(19) United States
(12) Patent Application Publication
(10) Pub. No.: US 2008/0147655 A1
(43) Pub. Date: Jun. 19, 2008

(54) VIRTUAL NETWORK OF REAL-WORLD ENTITIES

(76) Inventors: Alok Sinha, Bellevue, WA (US); Delane Hewett, Bellevue, WA (US)

Correspondence Address: PERKINS COIE LLP;PATENT-SEA, P.O. BOX 1247, SEATTLE, WA, 98111-1247, US

(21) Appl. No.: 11/870,405

(22) Filed: Oct. 10, 2007

Related U.S. Application Data
(60) Provisional application No. 60/850,840, filed on Oct. 10, 2006.
(60) Provisional application No. 60/876,029, filed on Dec. 19, 2006.
(60) Provisional application No. 60/940,867, filed on May 30, 2007.

(51) Int. Cl. G06F 17/30

(52) U.S. Cl. 707/6; 707/E17.014

(57) ABSTRACT

Methods and systems for providing a virtual network of real-world entities are provided. In various embodiments, the methods and systems receive a database identifying real-world entities wherein the database can include relationships between entities and attributes. Some attributes can be associated with strengths. Upon receiving a search query from a user, the methods and systems can dynamically match entities based on the received query and the strengths to provide a response to the received search query.

### CROSS-REFERENCES TO RELATED APPLICATIONS

This application claims the benefit of U.S. Provisional Patent Application Ser. No. 60/850,840, filed on Oct. 10, 2006, entitled “VIRTUAL NETWORK OF REAL-WORLD ENTITIES,” U.S. Provisional Patent Application Ser. No. 60/876,029, filed Dec. 19, 2006, entitled “FLEXIBLE DOMAIN HANDLING,” and U.S. Provisional Patent Application Ser. No. 60/940,867, filed May 30, 2007, entitled “VIRTUAL NETWORK OF REAL-WORLD ENTITIES,” which are all hereby incorporated herein in their entireties by reference.

### BACKGROUND

For decades, computers have been networked to exchange data. The Internet comprises a vast number of computers and computer networks interconnected through communication channels. The Internet is used for a variety of reasons, including electronic commerce, exchanging information such as electronic mail, retrieving information and doing research, and the like. Many standards have been established for exchanging information over the Internet, including the World Wide Web (“WWW”). The WWW service allows a server computer system (i.e., web server or web site) to send graphical web pages of information to a remote client computer system. The remote client computer system can then display the web pages. Each resource (e.g., computer or web page) of the WWW is uniquely identifiable by a Uniform Resource Locator (“URL”). To view a specific web page, a client computer system specifies the URL for that web page in a request (e.g., a HyperText Transfer Protocol (“HTTP”) request). The request is forwarded to the web server that supports that web page. When that web server receives the request, it sends the requested web page to the client computer system. When the client computer system receives that web page, it typically displays the web page using a browser. A browser is typically a special purpose application program for requesting and displaying web pages.

Currently, web pages are often defined using HyperText Markup Language (“HTML”). HTML provides a standard set of tags that define how a web page is to be displayed. When a user makes a request to the browser to display a web page, the browser sends the request to the server computer system to transfer to the client computer system an HTML document that defines the web page. When the requested HTML document is received by the client computer system, the browser displays the web page as defined by the HTML document. The HTML document contains various tags that control the display of text, graphics, controls, and other features. The HTML document may contain URLs of other web pages available on that server computer system or on other server computer systems.

New protocols exist, such as Extensible Mark-up Language (“XML”) and Wireless Access Protocol (“WAP”). XML provides greater flexibility over HTML. WAP provides, among other things, the ability to view web pages over hand-held, wireless devices, such as cell phones and portable computers (e.g., PDA's). All of these protocols provide easier ways to provide information to people via various data processing devices. Many other protocols and means for exchanging data between data processing device continue to develop to further aid the exchange of information.

Various companies offer WWW services that enable users to search for real estate properties. As examples, users can identify locations, price ranges, and so forth, to narrow down the large number of properties that are listed in various Multiple Listings Services. However, users may be interested in locating properties, activities, and services, using other criteria. Moreover, users may not even know what their criteria are. In such a case, it may be difficult to select properties, activities, and services that users may find interesting.

Traditional URLs typically use the file system namespace to address individual web pages. For example: http://myserver/myfolder/mypage.html is served from a physical page stored on c:\inetpub\wwwroot\myfolder\mypage.htm. IIS (or other internet platforms) convert the http request to a rendering of the page through this folder/file relationship. ASP/ASPX pages allow a single page to dynamically represent itself and change its output based on logic in server-side code. Additionally these dynamic pages can render client-side code that further change the behavior based on user actions on the page. Generally these pages are still defined to serve a specific function and are addressable by the file-system based relationship (e.g., http://myserver/myfolder/results.aspx?text=find%20this ).

Conventionally, one can also hand create “handlers” that are designed to do very specific things bypassing much of the IIS infrastructure and services. In such a case, every request may need to be handled and so much of the productivity of Internet Information Service (IIS) or other Internet server software can be lost.

Portal servers have been around for several years and represent a data-driven way to create virtual pages from a single set of utility pages. These portals provide a generic user interface using sets of standard controls (e.g., web parts) into predefined templates. Portals trade customized look, feel and functionality for flexibility and ease of administration. Generally these platforms are not capable of scaling to massive numbers of users or page views and so are not used for major commercial Internet sites.

The last few years have seen the emergence of sites based on combinations of XML Web Services, JavaScript, Cascading Style Sheets (CSS) and sometimes JavaScript Object Notation (JSON) services. These are commonly referred to as Ajax applications. These applications are generally based on a single or limited number of pages and instead of linking to different pages, change the context of the existing page through JavaScript callbacks. In this way, these applications have the benefit of passing small amounts of data back and forth to backend services (which can be disparate) and provide client-side changes to the UI representing some of the functionality typically associated with APPLE Macintosh or MICROSOFT WINDOWS applications. Like Portal servers, this approach has tradeoffs: Fast, commercial Ajax applications require a great deal of custom code and testing for each “page” rendered together with resolution of cross-browser issues. Frameworks such as MICROSOFT's ATLAS or RUBY use sets of general purpose JavaScript libraries and CSS files, together with tools to aid in the construction of cross-browser applications. Additionally, many third-parties developers have constructed portable, reusable components free and for sale called “widgets” or “gadgets.” These components can be used to enhance the functionality of Ajax sites. With this flexibility and reuse come additional costs. The majority of these applications are full of bloated, general-purpose JavaScript, files requiring many downloads to client computing devices. Though cached, these applications depend a great deal on the client's processor, memory and internet connection speed. Additional complexities such as deep links, SEO and forward/back navigation continue to plague Ajax applications.

Some companies have combined the concept of Portals and Ajax to allow users to create and host “custom” sites. These have all the limitations of traditional portals but end users get hosting for “free” (see, e.g., live.com, my.yahoo.com).

### BRIEF DESCRIPTION OF THE DRAWINGS

FIG. 1 is a block diagram of a basic and suitable computer that may employ aspects of the invention.

FIG. 2 is a block diagram illustrating a simple, yet suitable system in which aspects of the invention may operate in a networked computer environment.

FIG. 3 is a block diagram illustrating a portion of a database schema employed by the facility in some embodiments.

FIG. 4 is a block diagram illustrating a portion of a database schema employed by the facility in some embodiments.

FIGS. 5-6 are flow diagrams illustrating routines for providing a virtual network of real-world entities.

Note: the headings provided herein are for convenience and do not necessarily affect the scope or interpretation of the invention.

### DETAILED DESCRIPTION

Various embodiments of the invention will now be described. The following description provides specific details for a thorough understanding and enabling description of these embodiments. One skilled in the art will understand, however, that the invention may be practiced without many of these details. Additionally, some well-known structures or functions may not be shown or described in detail, so as to avoid unnecessarily obscuring the relevant description of the various embodiments.

The terminology used in the description presented below is intended to be interpreted in its broadest reasonable manner, even though it is being used in conjunction with a detailed description of certain specific embodiments of the invention. Certain terms may even be emphasized below; however, any terminology intended to be interpreted in any restricted manner will be overtly and specifically defined as such in this Detailed Description section.

A facility for providing a virtual network of interconnected real-world entities is described. Focus can be on an entity with a display template for each entity defined by the entity's class. Other entities displayed near the entity are determined by the ranking of interconnection between the entities. These rankings are derived by matching attributes between entities, but can change based on the behavior of users, individually or collectively.

In various embodiments, the facility can display, such as in Web page, real-world entities matching user interests and can enable users to explore natural or dynamic connections between entities to achieve various goals. The facility can represent entities with one or more attributes. Entities can be connected with each other by matching “natural” or “derived” attributes. In some embodiments, the facility includes a display engine to render user interface showing the entities and their inter-connections. The user, who is also an entity with attributes, can navigate the system by choosing inter-connections between entities or by explicitly providing attributes. The facility may then display in a ranked order entities that could be interesting to the user, entities with attributes that closely match those of the user or a group of users, or entities matching attributes of other entities that are determined to be interesting to the user.

Entities and their Attributes

Real-world entities can be represented in the virtual network of entities. Examples of such entities are: real estate, such as land, homes, condominiums, etc., available for sale or lease; recreational entities, such as boats, recreational vehicles, that are available for lease; timeshares; one time or recurring service offerings, such as plumbing or fueling; virtual word entities like web pages, message boards, web logs (“blogs”), or articles; and users and groups of users. A group of entities can be defined based on common attributes.

Entities can be virtual (e.g., services) or physical (e.g., things). In various embodiments, entities have a geo-location.

Each entity can have one or more primary attributes, also referred to as natural attributes. Examples are: price (attribute) of a home (entity), state or county in which rental cabin is available, number of engines in a boat, user name. Attributes may also be entities that have other attributes. As an example, “state” is an attribute of a rental cabin entity, but is also an entity itself that can have other attributes (e.g., population). An entity can have zero or more secondary or artificial attributes. Examples are: a travelogue (secondary attribute: geographical location (“geo-location”)) written for a given county (related entity by geo-location), pictures of nearby resort. Some attributes can be dynamically derived. Examples of dynamically derived attributes are: land with acreage between 10-50 acres, timeshares in places with sunshine 180 days or more, etc. Entities and their attributes can be entered into the network using manual or automated data entry mechanisms. However, derived attributes can be dynamically generated by the system.

Attributes can belong to attribute types. As an example, weekly rental price and daily rental price attributes may belong to an economic value attribute type. The attribute types may have a specified or implied ordering. As an example, the economic value attribute type may be more important than a physical characteristics attribute type. Color is an attribute of the physical characteristics attribute type.

An advantage of this attribute-based system is that each entity can have infinite attributes (created manually or dynamically). This makes the database schema storing this entity-attribute information immensely extensible.

Inter-Connection between Entities

Entities can be connected with each other, in a natural way or in dynamic way. A natural connection occurs when there is a natural match between attributes of entities. For example, land parcels (entity type=land) for sale in Montana (entity type=state) share a natural attribute (geo-location). Similarly, a book (entity type=book) for sale by a vendor (entity type=service) may also share a natural attribute (geo-location).

However, entities can be connected with each other by dynamic matching of attributes. For example, all condos in a town near a ski resort (attribute match: condos in 1-5 miles from ski resort).

The relationship of one entity to other is represented by a “strength” of an attribute. A home for sale in a town may have strength of 10 (close) while a cabin 100 miles from the town may have strength of 1 (distant). These strengths can be created dynamically at regular intervals by the system or changed by user behavior. A user's selection of a ski resort can increase the “ski buff” strength but slowly reduce the “chess player” attribute strength.

Thus, an “intersection” operation of common attributes can give rise to relationships between entities. As an example, an intersection of price ranges, nearby amenities or features, geo-location, etc., for multiple entities may identify a set of entities that a particular user may find interesting.

### Search and Navigation by Attribute Matching

A user can navigate the network of entities using free text search or by selecting links or other user interface elements.

As an example, the system can determine the attributes spelled out in text provided by the user (e.g., “land in Montana” shows all land listings in Montana) or by implicit intent (“Boat 39” implies all boats which have “35-40 foot” derived length attribute).

Attributes can be marked with various privileges, such as public, private, hidden, anonymous, etc. As an example, an electronic mail address can be a private attribute. As another example, a cellular telephone number may be a hidden attribute.

The facility may provide links, such as in a Web page. The links can be predetermined queries that use attributes. For example, a “Waterfront” link looks for all entities that have a “waterfront” attribute.

### Relevance and Ranking by Attribute Matching

Relevance of entities returned to the user is attempted by matching user attributes with those of the entities. The ranking of entities during attribute matching can be defined by the strength of the attribute being searched on. For example, ocean-front homes (attribute=ocean-front) could have a higher ranking in an attribute search of “view homes” around Newport (entity=town).

The result is that the user is provided entities which closely match their current predilections (until they change it by selecting a new path in their traversal of network).

### Dynamic Ranking Algorithm

Upon entry into the system, an entity can have a set of pre-programmed attributes and inter-connections (for example, a home in Flathead county, Montana, will have close match with Montana (state entity) and Flathead (county entity) due to geo-location attribute. These attributes and strengths of these attributes can define ranking.

However, the ranking dynamically changes over time as the user selects different paths through the network of entities. The displayed entities come into prominence (relevance) or fade away as the user refines the search or uses new attributes to search with.

In this example, a simple search for homes in Flathead country will show the home listing, but as the user clicks on kayaking-related entities (articles, advertisements, registers as a kayaker) homes closer to a river worth kayaking begin to appear (or get prominence).

The system also studies a user behavior as a cluster of other users with similar attributes. This is also used to re-calculate the ranking of entities surfaced to user.

Ranking of attributes or attribute types may be initially defined, such as when the attribute or type is added to the facility. These rankings may change, such as over time based on a user's interactions with the facility. As an example, a price attribute may be determined to be more important for one user but a geo-location attribute may be determined to be more important for another user. Users may also be able to specify rankings for attributes, either for a single transaction with the facility or for future transactions.

### Lifestyle Listing and Lifestyle Profile

The facility can be employed to provide a Lifestyle Listing and Lifestyle Profile features.

Lifestyle Listing includes displaying the listing (of home, land, boat, etc.) and related entities (pictures of nearby resorts, trail maps, local amenities and services, nearby homes, home association home page, articles, etc.).

Lifestyle Profile includes a collection of user interests that the user has explicitly provided (e.g., during user registration) or has shared by selecting displayed user interface elements (e.g., articles on kayaking).

The Lifestyle Profile may be computed over time. As examples, the Lifestyle Profile may initially be based on pre-computed attributes followed by clustering. During the clustering, a user may be associated with other users with similar interests. As an example, a user selecting a ranch for viewing further details may be associated with a cluster of users who also selected the ranch. The clustering can be modified by the user deliberately, by indicating areas of interest. The cluster of a user may be applied to another user, such as when a user sends to another user, via electronic mail, a link to the ranch so as to share listings. The other user may or may not be a “member,” whereas the user sending the link may be a member.

In various embodiments, the facility may enable targeted advertising or merchandising based on a user's derived or indicated affinity with attributes.

In various embodiments, the facility may enable categorization of attributes. When an entity has a specified or calculated attribute, the facility may automatically categorize the attribute, such as in a range. As an example, when a condominium is specified as having 1950 square feet, the facility may categorize the condominium as having 1500-2000 square feet. When the facility indexes attributes, it may also index the categorizations. Then, a user may be able to search for all entities having attributes within the categorizations (e.g., range of square feet).

In various embodiments, the facility can be employed to view data that it collects pertaining to user activities. As an example the facility can provide information about entity-attribute relationships that are likely to be selected by users.

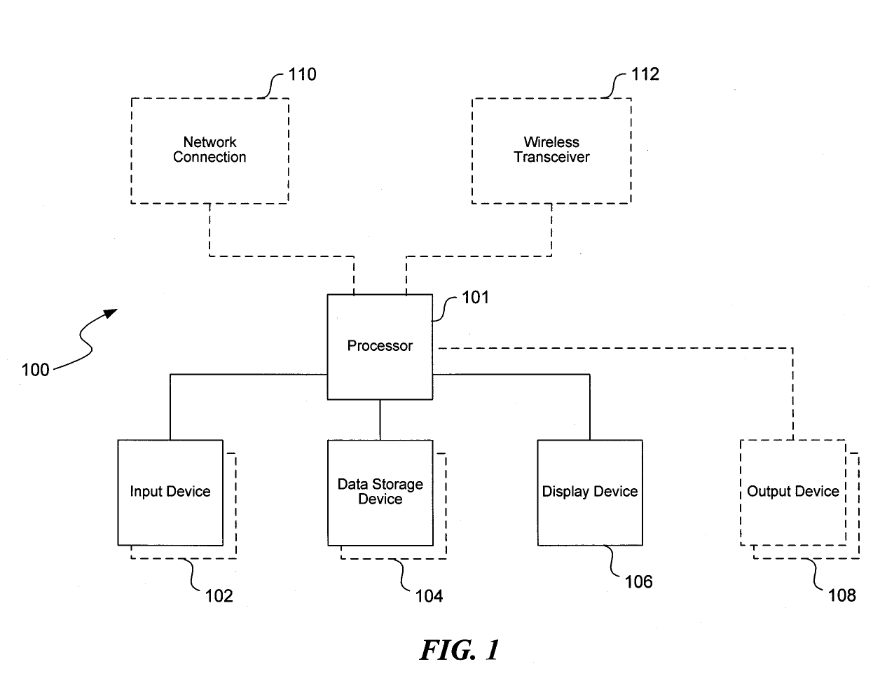

FIG. 1 and the following discussion provide a brief, general description of a suitable computing environment in which aspects of the invention can be implemented. Although not required, aspects and embodiments of the invention will be described in the general context of computer-executable instructions, such as routines executed by a general-purpose computer, e.g., a server or personal computer. Those skilled in the relevant art will appreciate that the invention can be practiced with other computer system configurations, including Internet appliances, hand-held devices, wearable computers, cellular or mobile phones, multi-processor systems, microprocessor-based or programmable consumer electronics, set-top boxes, network PCs, mini-computers, mainframe computers and the like. The invention can be embodied in a special purpose computer or data processor that is specifically programmed, configured or constructed to perform one or more of the computer-executable instructions explained in detail below. Indeed, the term “computer,” as used generally herein, refers to any of the above devices, as well as any data processor or any device capable of communicating with a network, including consumer electronic goods such as game devices, cameras, or other electronic devices having a processor and other components, e.g., network communication circuitry.

The invention can also be practiced in distributed computing environments, where tasks or modules are performed by remote processing devices, which are linked through a communications network, such as a Local Area Network (“LAN”), Wide Area Network (“WAN”) or the Internet. In a distributed computing environment, program modules or sub-routines may be located in both local and remote memory storage devices. Aspects of the invention described below may be stored or distributed on computer-readable media, including magnetic and optically readable and removable computer discs, stored as firmware in chips (e.g., EEPROM chips), as well as distributed electronically over the Internet or over other networks (including wireless networks). Those skilled in the relevant art will recognize that portions of the invention may reside on a server computer, while corresponding portions reside on a client computer. Data structures and transmission of data particular to aspects of the invention are also encompassed within the scope of the invention.

Referring to FIG. 1, one embodiment of the invention employs a computer 100, such as a personal computer or workstation, having one or more processors 101 coupled to one or more user input devices 102 and data storage devices 104. The computer is also coupled to at least one output device such as a display device 106 and one or more optional additional output devices 108 (e.g., printer, plotter, speakers, tactile or olfactory output devices, etc.). The computer may be coupled to external computers, such as via an optional network connection 110, a wireless transceiver 112, or both.

The input devices 102 may include a keyboard and/or a pointing device such as a mouse. Other input devices are possible such as a microphone, joystick, pen, game pad, scanner, digital camera, video camera, and the like. The data storage devices 104 may include any type of computer-readable media that can store data accessible by the computer 100, such as magnetic hard and floppy disk drives, optical disk drives, magnetic cassettes, tape drives, flash memory cards, digital video disks (DVDs), Bernoulli cartridges, RAMs, ROMs, smart cards, etc. Indeed, any medium for storing or transmitting computer-readable instructions and data may be employed, including a connection port to or node on a network such as a local area network (LAN), wide area network (WAN) or the Internet (not shown in FIG. 1).

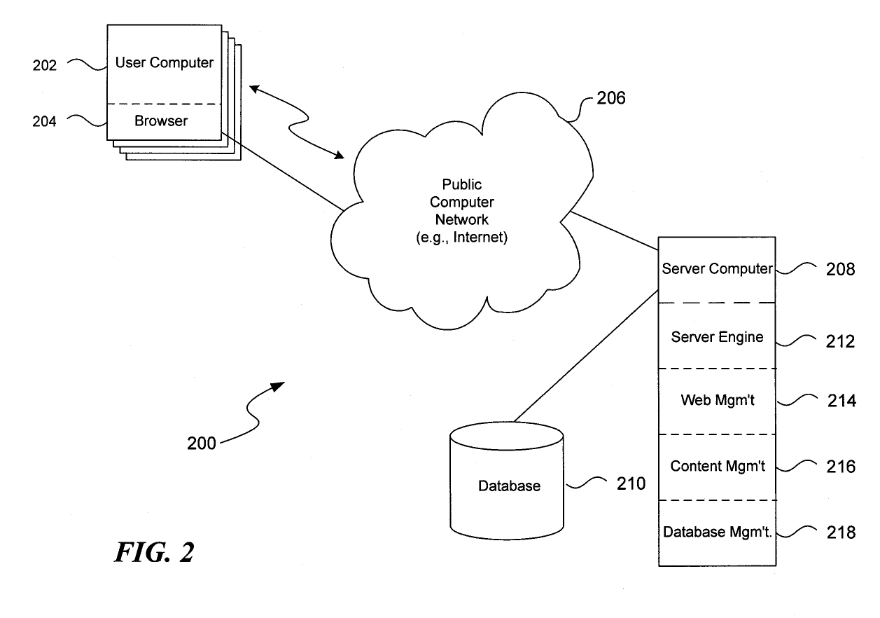

Aspects of the invention may be practiced in a variety of other computing environments. For example, referring to FIG. 2, a distributed computing environment with a web interface includes one or more user computers 202 in a system 200 are shown, each of which includes a browser program module 204 that permits the computer to access and exchange data with the Internet 206, including web sites within the World Wide Web portion of the Internet. The user computers may be substantially similar to the computer described above with respect to FIG. 1. User computers may include other program modules such as an operating system, one or more application programs (e.g., word processing or spread sheet applications), and the like. The computers may be general-purpose devices that can be programmed to run various types of applications, or they may be single-purpose devices optimized or limited to a particular function or class of functions. More importantly, while shown with web browsers, any application program for providing a graphical user interface to users may be employed, as described in detail below; the use of a web browser and web interface are only used as a familiar example here.

At least one server computer 208, coupled to the Internet or World Wide Web (“Web”) 206, performs much or all of the functions for receiving, routing and storing of electronic messages, such as web pages, audio signals, and electronic images. While the Internet is shown, a private network, such as an intranet may indeed be preferred in some applications. The network may have a client-server architecture, in which a computer is dedicated to serving other client computers, or it may have other architectures such as a peer-to-peer, in which one or more computers serve simultaneously as servers and clients. A database 210 or databases, coupled to the server computer(s), stores much of the web pages and content exchanged between the user computers. The server computer(s), including the database(s), may employ security measures to inhibit malicious attacks on the system, and to preserve integrity of the messages and data stored therein (e.g., firewall systems, secure socket layers (SSL), password protection schemes, encryption, and the like).

The server computer 208 may include a server engine 212, a web page management component 214, a content management component 216 and a database management component 218. The server engine performs basic processing and operating system level tasks. The web page management component handles creation and display or routing of web pages. Users may access the server computer by means of a URL associated therewith. The content management component handles most of the functions in the embodiments described herein. The database management component includes storage and retrieval tasks with respect to the database, queries to the database, and storage of data.

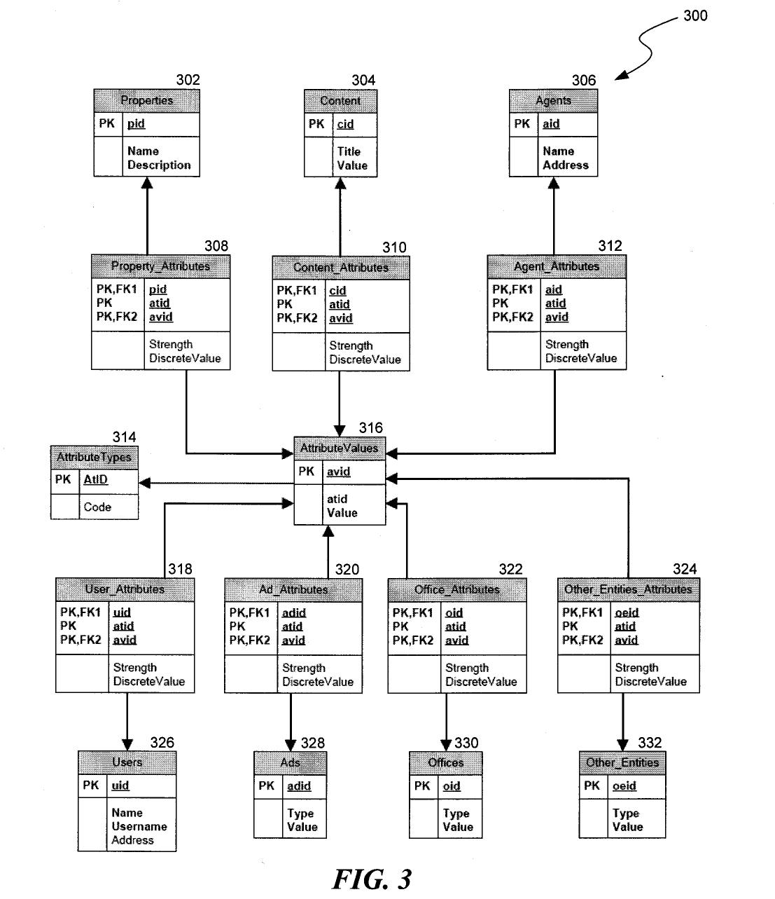

FIG. 3 is a block diagram illustrating a portion of a database schema employed by the facility in some embodiments. Tables associated with the database schema are identified. These tables can have primary keys (“PK”) and foreign keys (“FK”). The tables store information relating to various entities and attributes. The schema can be extended.

A database schema includes a properties table 302. The properties table can store the names and descriptions of properties, such as real estate properties. The properties table has a related Property_Attributes table 308. The Property_Attributes table can store strength and relationships between properties and attribute values. As an example, the Property_Attributes table can indicate that a particular property has an identifying value. The database schema also includes a content table 304 and a Content_Attributes table 310. Similar to the Property_Attributes table, the Content_Attributes table establishes relationships between content values and attribute values. The attribute values are specified in an AttributeValues table 316. The database schema includes an agents table 306 and an Agent_Attributes table 312. The AttributeValues table 316 can also be associated with attribute types that are listed in an AttributesTypes table 314. The database schema can also identify users in a Users table 326, advertisements in an Ads table 328, offices in an Offices table 330, and other entities in an Other_Entities table 332. These tables can be associated with AttributeValues via User_Attributes table 318, Ad_Attributes table 320, Office_Attributes table 322, and an Other_Entities_Attributes table 324.

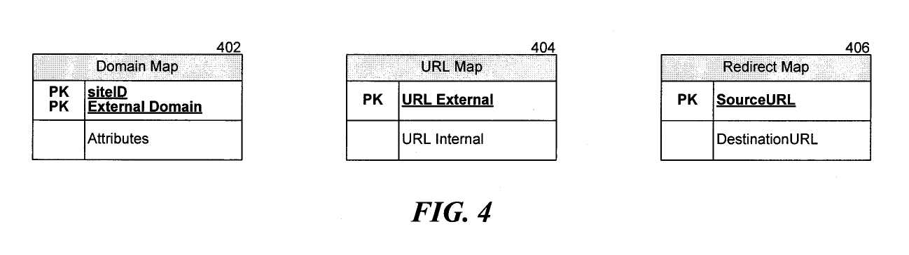

FIG. 4 is a block diagram illustrating a portion of a database schema employed by the facility in some embodiments. The database schema includes Domain Map 402, URL Map 404, and Redirect Map 406 tables.

The described technology can satisfy several design objectives:
1. Scalable to thousands of page views/second
2. Sub-second response from all pages
3. Potential for hundreds to thousands of “separate” sites each with the possibility of hundreds of pages
4. Ability to define and serve pages based on designer requirements (i.e., custom look and feel)
5. Ability to manage the addition of new sites, changes to sites and scheduling of these changes without technical involvement.
6. Ability to enhance the platform through addition of new complex features.
7. Ability to personalize every page view based on user interest and intent
8. Ability to present a pleasing “Web 2.0” experience.
9. Optimized SEO including crawler friendly URL's, deep links and sitemaps
10. Clear separation between layout, content and functionality, all of which can be shared across sites and pages

To get the flexibility in the number of sites and pages, the technology does not employ a file-based system. The technology also decreases sizes of files.

To get the scalability and performance desired, the technology controls the size of the download and so frameworks such as Atlas are less useful. To generate and maintain pages without developer support, content management is built into the platform. In some embodiments, all pages regardless of site, function, or features are served from a single (“DOT-NET”) page.

Since all pages in the platform can be served from a single, data-driven page, the technology includes a “page” addressing scheme similar to URLs. Additionally, the technology supports any number of domains and sub domains and maintains some domains while redirecting others. Every page on every domain can be represented with a single URL scheme. To accomplish this, the technology creates three models: Domain Maps, URL Maps and Redirect Maps.

Domain maps manage the various domains and sub domains on each site. They represent a data-driven generated mapping between the external domain portion of the URL (e.g., http://www.landwatch.com, http://hunting.landwatch.com) and the internal representation. Additionally any sub domain may be represented simply as the primary domain but with one or more attributes appended to the internal representation. In the previous example, http://hunting.landwatch.com represents the http://www.landwatch.com site with an additional context of “hunting” applied to all content and features of the site. In these embodiments, the site would appear to the user to be http://www.landwatch.com but with a distinct “hunting” flavor. The Domains can be maintained throughout a user's session in every URL.

URL Maps can be used to abstract the internal representation of any and all sites while providing a URL representation for external crawlers to use that is also optimized for search engines. URL Maps focus on the part of the URL not included in the domain map. For example, for the URL: http://myserver/myfolder/results.aspx?text=find%20this, this would be “/myfolder/results.aspx?text=find%20this.” The URL Map contains external (search engine-friendly, public facing) URLs, Internal URLs, whether the virtual page is shown on the XML-based sitemaps and the crawl priority.

The combination of results from the Domain Map and the URL Map provide complete friendly URLs that uniquely describe each “page” of each site even though there is really only one ASP.NET page on the site.

The Redirect Map is used to forward legacy URLs, handle URLS that have a preceding “WWW,” and those that do not and to forward multiple URLs to a single URL. In all these cases the passed-in URL is not maintained and actual “301” redirects are employed.

These mechanisms enable the technology to represent any page on any site in a consistent user-friendly and search engine-friendly manner while simultaneously maintaining multiple search-optimized Site Maps.

Referring again to FIG. 4, sample data in the Domain Map table may be:

| SiteID | ExternalDomain | Attributes |
|---|---|---|
| 1 | http://www.landwatch.com | NULL |
| 1 | http://JohnSmith.Landwatch.com | AgentName = “John Smith” |
| 1 | http://Hunting.Landwatch.com | Activity = “Hunting” |
| 2 | http://Recent.JohnSmith.Com | Context = “Recent” |

Sample data in the URL Map table may be:

| URLExternal | URLInternal |
|---|---|
| /Montana_Land_for_Sale | /default.aspx?ct=r&type=5,56 |
| /Montana_Land_for_Sale/Hunting | /default.aspx?ct=r&type=5,56;11,213 |
| /sign-up | /default.aspx?ct=c&type=CTYP,user%20sign%20up |
| / | /default.aspx?ct=c&type=CTYP,home%20page |

Sample data in the Redirect Map table may be:

| SourceURL | DestinationURL |
|---|---|
| http://landwatch.com | http://www.landwatch.com |
| http://montanalandforsale.com | http://www.landwatch.com |
| http://JohnSmith.com | http://JohnSmith.landwatch.com |

Using these three together, the technology can at any point in time determine the context of the site and page. For example http://JohnSmith.landwatch.com/Montana_Land_for_Sale/Hunting will exhibit the following behavior:
1. http://JohnSmith.landwatch.com indicates that the site to render is “1” based on the siteID. For the rest of the user's session, the user will continue to see the prefix of the URL: http://JohnSmith.landwatch.com for each page they visit. SiteID 1 indicates how to lay-out the page and what themes (or Skins) to apply for visual appearance. Additionally the technology applies the attribute “AgentName=“John Smith.”
2. The second part of the URL “/Montana_Land_for_Sale/Hunting” indicates the Search Engine Optimized (SEO) “Friendly” URL. This contains all the best descriptive words, signaling crawlers to show this URL when these particular words are searched for.
3. In the URL Map table, for example, “/Montana_Land_for_Sale/Hunting” also refers to “/default.aspx?ct=r&type=5,56;11,213” which indicates that the context of the page is “Search results” (ct=r) and of the content and results to show on this particular page. In this case, the technology shows all of the properties with attributes “State=Montana” (type 5,56) and “Activity=Hunting” (type 11,213).
4. The effect of this page is to show a results page showing a list of all of John Smiths properties in Montana that are considered hunting properties.
5. Since the “John Smith” attribute is on the Domain part of the URL, it will be preserved for every page the users view on the site. In this way every page they view while on the site will be filtered by the attribute “AgentName=“John Smith.” The technology uses this to display custom content or a custom presentation for each page.
6. Additionally, if a user comes in with the URL http://JohnSmith.com, they will be directed to http://JohnSmith.landwatch.com as is evident in the Redirect Map table.

Thus, the technology enables the following:
1. URLs optimized for user understanding and SEO;
2. Factors attributes into the URLs and uses these attributes to filter the context, content and/or results;
3. Redirects alternate URLs or legacy URLs to the optimized new strategy optimizing page relevancy of the destination URLs;
4. Separates the context of the page (primary function) from the URL and enables it to utilize any attributes;
5. One page can literally serve any page of any site in any context; and
6. Hides the complexity of the “one-page serves all” design.
   Transition from Search to Inference

The disclosed technology (“system”) enables a user, by employing search or navigation, to find entities of interest contained in the system. When the user does so, the system learns about the user's interests as the user interacts with the system and creates a user profile in “real time.” The system can use the user profile to infer the relevance (LifeStyle Relevance™) of entities to render to the user in real time (also referred to as LifeStyle Search™). Furthermore, the system can make suggestions on entities that are not directly searched for by the user but are inferred by the system as to most likely entities of interest to user (LifeStyle Inference™).

Although the following examples are real-estate oriented, the system is completely capable of handling any type of entity.

### Entity

In the system, an entity can be a specific, real-world or virtual item with one or more attributes. For example, a piece of land is an entity with attributes of acreage, price, and proximity to nearest golf course. Conversely, a hunting knife is an entity with attributes of price, shape, color, and hunting.

The relationship of one entity to other is represented by means of strength of an attribute. A home for sale in town may have strength of 10 (close) while a cabin 100 miles from town may have strength of 1 (distant). These strengths are created dynamically at regular intervals by the system or changed by user behavior. A user clicking on Ski resort increases the “ski buff” strength while slowly reducing the “chess player” attribute strength.

### Attribute-Based Search and Navigation

A user finds a list of entities with an attribute-based query. For example, a query like “hunting land in Montana for elk hunting” will return a set of land parcels which have the attributes of “state=MT,” “parcel type=land,” “hunting=true,” “elk hunting=true.”

In this process, the system determines the attributes that are directly expressed or indirectly implied by the user. Next, the system identifies entities that have these attributes (either pre-set or derived in real-time). The system can present to the user those entities that have a stronger relationship (e.g., by looking up strength of attribute) with the original entity. For example, the system can show a property marked “elk hunting” before showing another property marked “deer hunting.” In this way, the system can find common relationships (attributes are the edges between entities, strength being the closeness between the two entities) between a set of entities and thus, these embodiments are similar to the concept of Semantic web.

The system enables a user to navigate by clicking on a menu option, link, or picture. When this occurs, the system executes a query corresponding to the selected item.

The system conducts a proximity search (e.g., price ranges, acreage range). For example, when a user says “hiking boots $100,” the system can show the user shoes which fall in a given range (say $50-200). Similarly, some attributes are explicit (e.g., price of a land) and some are derived (e.g., nearest park). The search feature of the system manages both types of attributes. Similarly, when matching attributes, the system looks up not only the specific word but also synonyms (e.g., Power=Electricity).

Additionally, instead of searching for the words associated with a document (e.g., listings in real estate instance of system), the system can take words, phrases (“n-grams”) and explicit human/machine defined attributes, and compare them with a dictionary of synonyms, values and classifications. The system can then look for other entities (documents) with various degrees of matched attributes and order them by a distance function. The search also uses a variation of “contextual search” in that it compares n-grams to properly extract attributes.

### LifeStyle Profile™

As the user navigates the system, from signup wizards to clicking on a link or content module, the system can re-compute user attributes (LifeStyle Profile™) and strengths of these attributes (the user is an entity as well). For example, if the system were to display shoes and the user keeps clicking on red colored shoes from Italy, her “red shoe” and “Italian made” attributes strengths will grow in real time. Conversely, if the user has not selected a set of entities over a period of time, the strengths of those attribute will decay over time.

### LifeStyle Relevance

When a user conducts a search, the user receives in response a list of entities based on intersection of results of attribute based search and user profile, with strongest matches shown at the top of result set. For example, if the user has shown a strong inclination of being a hiker and is looking for land in Montana, the user may be shown those listings with attributes liked by hikers (e.g., close to national park) first. This combination of reducing the entity set and sorting by user profile can be referred to as LifeStyle Relevance. This is also the default sort order in the system whenever lists of entities are returned from the system.

### LifeStyle Search

The system may show entities in which the user might be indirectly have interest in addition to user entities the user has directly expressed an interest in. For example, if the user types in “Hiking Shoes” and the system has determined that the user is interested in medium to hard hikes, the system can show not only hiking shoes but related merchandise (e.g., hiking clothing, trail maps), services (e.g., hiking guide), nearby real estate (e.g., cabins, rentals).

This allows the user who only wanted to find a specific item (hiking shoes in example above) but also others who are more in discovery mode as it relates to a lifestyle.

Additionally, the system can also show to the user a section called “You Might Also Like (YMAL)” some more entities based on these two matching:

Discovery. The system shows those entities which match most of the requested attributes during discovery/research. For example, if the user typed in ‘Ski Vacation in Aspen,’ the main search results will show rentals, houses, services, etc., for Aspen but in the YMAL section, it may show ski cabins in Big Sky (MT). This helps users in discovery phase of their search.

Collaborative Filtering. Additionally, the system can show to the user those listings which other people with similar user profile are clicking on. This is based on collaborative filtering. Thus, in the example above, in the YMAL section, the system can show a few entities which other skier are clicking on (e.g., Ski Vacation In Italy).

### LifeStyle Inference

Thus, the system provides an inference engine for a given domain. When a database includes relevant entities for a given domain (e.g., real estate) and relationships between them (e.g., attributes and strength), the system can employ the database described above to show to users entities that they may have meant to seek instead of or in addition to their actual search.

In this way, the described system is superior (by using attribute search) to conventional search (Web 1.0) which is based on documentation crawl, and is also better (by inferring user needs) than semantic search (Web 3.0) since it is implemented in a more simplified manner by storing the data in a database instead of connecting to many disparate systems to create relationships that users navigate.

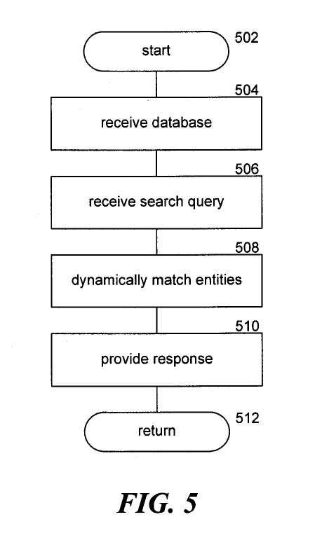

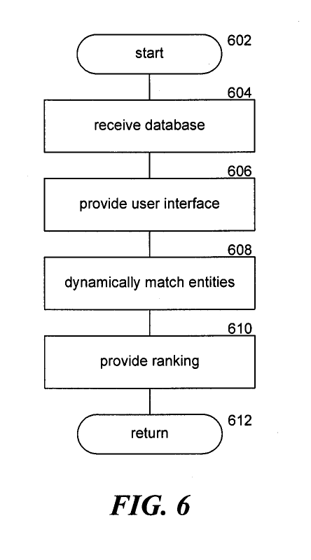

FIGS. 5-6 are flow diagrams illustrating routines for providing a virtual network of real-world entities.

According to FIG. 5, the system receives a database at block 504 identifying real-world entities. The database can include identifications of entities, attributes relating to those entities, and relationships between the entities wherein an attribute is associated with a strength. At block 506, the routine receives a search query. At block 508, the routine dynamically matches a first entity with a second entity using an attribute corresponding to the first and second entities wherein the second entity is matched with the first entity using the strength of the attribute when the strength of the attribute for the first and second entities is higher than the strength of the attribute for a third entity. Multiple entities can be matched. At block 510, the routine provides a response.

According to FIG. 6, the system receives a database identifying real-world entities at block 604. The database can include identifications of entities, attributes relating to those entities, and relationships between the entities wherein an attribute is associated with a strength. At block 606, the routine provides a user interface to a user. The user interface can identify entities and attributes. At block 608, the routine dynamically ranks entities with an interest level corresponding to perceived user interest for a user based on interactions between the user and the provided user interface wherein the ranking is based on the strength. At block 610, the routine provides a ranking.

In general, the detailed description of embodiments of the invention is not intended to be exhaustive or to limit the invention to the precise form disclosed above. While specific embodiments of, and examples for, the invention are described above for illustrative purposes, various equivalent modifications are possible within the scope of the invention, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified. Each of these processes or blocks may be implemented in a variety of different ways. Also, while processes or blocks are at times shown as being performed in series, these processes or blocks may instead be performed in parallel, or may be performed at different times.

Aspects of the invention may be stored or distributed on computer-readable media, including magnetically or optically readable computer discs, hard-wired or preprogrammed chips (e.g., EEPROM semiconductor chips), nanotechnology memory, biological memory, or other data storage media. Indeed, computer implemented instructions, data structures, screen displays, and other data under aspects of the invention may be distributed over the Internet or over other networks (including wireless networks), on a propagated signal on a propagation medium (e.g., an electromagnetic wave(s), a sound wave, etc.) over a period of time, or they may be provided on any analog or digital network (packet switched, circuit switched, or other scheme). Those skilled in the relevant art will recognize that portions of the invention reside on a server computer, while corresponding portions reside on a client computer such as a mobile or portable device, and thus, while certain hardware platforms are described herein, aspects of the invention are equally applicable to nodes on a network.

The teachings of the invention provided herein can be applied to other systems, not necessarily the system described herein. The elements and acts of the various embodiments described herein can be combined to provide further embodiments.

These and other changes can be made to the invention in light of the above Detailed Description. While the above description details certain embodiments of the invention and describes the best mode contemplated, no matter how detailed the above appears in text, the invention can be practiced in many ways. Details of the invention may vary considerably in its implementation details, while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific embodiments disclosed in the specification, unless the above Detailed Description section explicitly defines such terms. Accordingly, the actual scope of the invention encompasses not only the disclosed embodiments, but also all equivalent ways of practicing or implementing the invention.

We claim:

1. A method performed by a computing device for providing a virtual network of real-world entities, comprising:
receiving a database identifying real-world entities, the database including identifications of entities, attributes relating to those entities, and relationships between the entities wherein an attribute is associated with a strength;
receiving a search query; and
dynamically matching a first entity with a second entity using an attribute corresponding to the first and second entities wherein the second entity is matched with the first entity using the strength of the attribute when the strength of the attribute for the first and second entities is higher than the strength of the attribute for a third entity.

2. The method of claim 1 further comprising providing a response to the search query wherein the response includes the dynamically matched entities.

3. The method of claim 1 further comprising providing a response to the search query wherein the response includes the dynamically matched entities wherein the providing includes performing an intersection operation of common attributes.

4. The method of claim 1 wherein the matching occurs over time based on searches performed by a user.

5. The method of claim 1 wherein the matching occurs over time based on observations of interactions a user selects with a user interface.

6. The method of claim 1 wherein the matching occurs over time based partially on the search query wherein the search query is text.

7. The method of claim 1 wherein when an attribute is marked with a privilege indicating that a user cannot access the attribute, the attribute is not included in the matching.

8. A computer-readable medium storing computer-executable instructions that, when executed, cause a computing device to perform a method of providing a virtual network of real-world entities, the method comprising:
receiving a database identifying real-world entities, the database including identifications of entities, attributes relating to those entities, and relationships between the entities wherein an attribute is associated with a strength;
providing a user interface to a user, the user interface identifying entities and attributes; and
dynamically ranking entities with an interest level corresponding to perceived user interest for a user based on interactions between the user and the provided user interface wherein the ranking is based on the strength.

9. The computer-readable medium of claim 8 further comprising receiving a set of pre-programmed attributes and inter-connections between the pre-programmed attributes and the real-world entities and including the received set of pre-programmed attributes and inter-connections in the dynamic ranking based on their corresponding strengths.

10. The computer-readable medium of claim 8 further comprising changing the dynamic ranking over time based on observed user interactions with the provided user interface.

11. The computer-readable medium of claim 8 wherein the database includes indications of geo-locations in attributes associated with entities.

12. The computer-readable medium of claim 8 wherein the database includes an initial ranking of an attribute that changes over time.

13. A system for providing a virtual network of real-world entities, comprising:
a lifestyle listing component that includes a listing of a real-world entity and an indication of associated entities; and
a lifestyle profile component that tracks a collection of user interests associated with the lifestyle listing component.

14. The system of claim 13 wherein the lifestyle profile is computed over time based on user interactions with the lifestyle listing.

15. The system of claim 13 wherein a first user is associated with a second user during a clustering process so that the second user's preferences are associated with the first user.

16. The system of claim 13 wherein a first user is associated with a second user during a clustering process so that the second user's preferences are associated with the first user and thereafter modified by the first user by indicating an area of interest.

17. The system of claim 13 further comprising an advertisement component that identifies an advertisement for a user based on the user's determined interest.
